(19) United States
(12) Patent Application Publication
(10) Pub. No.: US 2017/0323270 A1
(43) Pub. Date: Nov. 9, 2017

(54) GEO-LOCATION BASED MATCHING OF DIGITAL PROFILES

(71) Applicant: SAP SE, Walldorf (DE)

(72) Inventor: Steve Gibbs, Harleysville, PA (US)

(21) Appl. No.: 15/149,297

(22) Filed: May 9, 2016

(51) Int. Cl. G06Q 10/10; G01S 19/13

(52) U.S. Cl. CPC G06Q 10/1053; G01S 19/13

(57) ABSTRACT

Provided are a system and method for performing a job search using a digital profile of a user. In one example, the method includes providing an assessment comprising a plurality of questions to a user, generating a digital profile based on answers by the user to the questions included in the assessment, the digital profile including attributes of the user that are determined by a profile server based on the answers, comparing the digital profile to available job opportunities to determine an available job opportunity having predetermined attributes matched by the attributes of the digital profile, and providing information about the available job opportunity having predetermined attributes matched by the attributes of the digital profile to a mobile device of the user.

### BACKGROUND

Employers need properly skilled and trainable talent in order to succeed, grow, and prosper. The supply of skilled job seekers looking for new and challenging career opportunities is constantly evolving. However, providing an arena for qualified individuals to interact with employers looking for their talent has been difficult. When searching for a job opportunity, a job seeker is most likely to use web-based search engines, job boards, social networking services, headhunters, and even cold-calling friends and family members for ideas and opportunities. When a job seeker finally locates a potential job opportunity that is of interest, the job seeker typically submits a resume and a cover letter, along with any additional submissions requested by the employer such as writing samples, licensing certificates, letters of recommendation, and the like. However, a traditional resume and/or cover letter does not come close to providing an understanding of the person. For example, while the resume may list certain criteria, work history, schooling, and the like, it is still difficult to gauge the kind of personality the job seeker has, their career objectives, what kind of ambitions they have, what are their particular skills with respect to your business, and so forth. Also, job seekers will often include information in their resume which is not accurate in order to improve their chances of receiving a job offer.

Meanwhile, it is also difficult for employers to provide information about their organization and available job opportunities to potential job seekers. If a person is actively searching for a job, then the person might come across a job opening posted by the employer. However, if the person is not actively looking for a job, or not searching in the exact right place, they are not likely going to find the job opportunity. Instead, they are most likely searching for non-job related information and are not likely to come across any job opportunity. Also, even if a person is searching for a job, there are still a number of job opportunities of interest and which they are qualified for, which go undetected due to many factors, such as failing to search in the exact job category or location, lack of awareness of various job boards, lack of effort, and the like. Articulating the skills, competencies, and culture of a company to a diverse and changing market of job seekers combined with the inconsistent search habits and tools of job seekers causes a continual obstacle that prevents efficiency gains and reduction in operational costs in the global recruiting market.

### SUMMARY

In one aspect, there is provided a server that may include a receiver to receive answers from a user of a mobile device to questions included in an assessment and to receive recurring travel pattern information of the mobile device detected by a global positioning system (GPS) detector of the mobile device, a generator to generate a digital profile based on the answers by the user to the questions included in the assessment, the digital profile including attributes of the user that are determined based on the answers, a comparator to compare the digital profile to available job opportunities to determine an available job opportunity having predetermined attributes matched by the attributes of the digital profile, and a transmitter configured to automatically push information about the available job opportunity having predetermined attributes matched by the attributes of the digital profile to the mobile device of the user, in response to the available job opportunity having a geo-location within a predetermined distance from a geo-location of the recurring travel pattern information.

In another aspect, there is provided a mobile device that may include a processor to receive an assessment from a server and generate a digital profile of a user of the mobile device based on answers of the user to questions included in the assessment, a global positioning system (GPS) detector to detect recurring travel pattern information of the mobile device, a transmitter to transmit a user selection of attributes included in the digital profile and the recurring travel pattern information to the application server, and a receiver configured to receive a notification about an available job opportunity for the user which is automatically pushed from the server, in response to predetermined attributes of the available job opportunity being matched by the user selected attributes of the digital profile and in response to the available job opportunity having a geo-location within a predetermined distance from a geo-location of the recurring travel pattern information.

In another aspect, there is provided a computer-implemented method that may include providing an assessment including a plurality of questions to a user, generating a digital profile based on answers by the user to the questions included in the assessment, the digital profile including attributes of the user that are determined by a profile server based on the answers, receiving recurring travel pattern information of the mobile device detected by a global positioning system (GPS) detector of the mobile device, comparing the digital profile to available job opportunities to determine an available job opportunity having predetermined attributes matched by the attributes of the digital profile, and automatically pushing information about the available job opportunity having predetermined attributes matched by the attributes of the digital profile to the mobile device of the user, in response to the available job opportunity having a geo-location within a predetermined distance from a geo-location of the recurring travel pattern information.

In another aspect, there is provided a non-transitory computer readable medium having stored therein instructions that when executed cause a computer to perform a method that may include providing an assessment including a plurality of questions to a user, generating a digital profile based on answers by the user to the questions included in the assessment, the digital profile including attributes of the user that are determined by a profile server based on the answers, receiving recurring travel pattern information of the mobile device detected by a global positioning system (GPS) detector of the mobile device, comparing the digital profile to available job opportunities to determine an available job opportunity having predetermined attributes matched by the attributes of the digital profile, and automatically pushing information about the available job opportunity having predetermined attributes matched by the attributes of the digital profile to the mobile device of the user, in response to the available job opportunity having a geo-location within a predetermined distance from a geo-location of the recurring travel pattern information.

Other features and aspects will be apparent from the following detailed description, the drawings, and the claims.

### BRIEF DESCRIPTION OF THE DRAWINGS

Features and advantages of the various embodiments, and the manner in which the same are accomplished, will become more readily apparent with reference to the following detailed description taken in conjunction with the accompanying drawings.

FIG. 1 is a diagram illustrating an overview of a system in which available job opportunities may be provided to a user based on a digital smart profile of the user, in accordance with an embodiment.

FIG. 2 is a diagram illustrating a listing of attributes of a user that may be included in a digital smart profile in accordance with an embodiment.

FIGS. 3 and 4 are diagrams illustrating personality evaluations that may be generated from and/or included within a digital smart profile in accordance with embodiments.

FIG. 5 is a diagram illustrating a display screen of a mobile device showing available job opportunities available to a user based on their digital smart profile in accordance with an embodiment.

FIG. 6 is a diagram illustrating a management server in accordance with an embodiment.

FIG. 7 is a diagram illustrating a method of a management server in accordance with an embodiment.

FIG. 8 is a diagram illustrating a mobile device in accordance with an embodiment.

FIG. 9 is a diagram illustrating a method of a mobile device in accordance with an embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various embodiments. It should be appreciated that various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The embodiments relate to an application that can provide available employment opportunity information to a user through their mobile device. The application may be managed by a management server and may be downloaded from the management server and installed on the user's device. As an example, the application may be a web application, a mobile application, and the like. The user may build a digital smart profile (also referred to as smart digital profile or digital profile) including a digitized representation of various attributes of the user, for example, skills, motivations, interests, hobbies, drives, and/or the like. The digital smart profile may be generated based on various personal information and/or structured assessments that are provided by the server. The assessments may be used to identify information about the user that may not be readily apparent from traditional employment documents such as a resume or cover letter. For example, the assessments may include questions that prompt answers from the user. The answers may enable competencies, personality traits, subjective skills relative to a particular job, and other information of interest to an employer, to be identified and/or challenged. The assessments may include customized questions provided by an employer and/or standardized questions from any previously known assessments such as those provided by Company Executive Board (CEB), SHL, and the like. In some examples, the user may be in total control over the digital smart profile and may control which attributes, and other related information are used to search for available job opportunities.

Entities such as companies, organizations, businesses, and the like, may also join or otherwise access the mobile based application through the management server. The entities (generally referred to herein as “employers”) may provide the server with various job opportunities that are available and specific attributes that they are looking for in potential job seekers. As another example, the entities may broadcast available employment information and specific attributes which may be detected by the user's mobile device and/or the management server. The specific attributes may go well beyond educational degrees, work experience, employment history, etc., and focus on various attributes of the job seeker, for example, personality traits, ambitions, career goals, motivations, and the like. In addition, the employer may also provide a geographical location(s) of the job opportunity or indicate that the job is a virtual job that can be performed anywhere.

According to various embodiments, a user represented by a digital smart profile may receive information about available job opportunities from the management server based on the digital smart profile. In this case, the management server may match the digital smart profile of the user to business profiles or business needs of a particular entity. As an example, the user may turn on a search function of the digital smart profile application installed on their device and the application may search for available jobs within a proximity of the user based on attributes of the user included in their respective digital smart profile. Rather than receive a search query or key word search for job opportunities from the user, the application may automatically push available job opportunity notifications to the user's mobile device based on the attributes included in the digital smart profile and without a request from the user. For example, if the user's digital smart profile satisfies a predetermined amount of attributes or matches a predetermined amount of attributes of an available job opportunity (e.g., 50%, 75%, 90%, etc.) the management server may push a notification of the available job opportunity satisfied by the user's digital smart profile to the user's device. For example, an available job opportunity may have a requirement that 60% of the attributes of the job are matched by attributes of the user's digital smart profile. In these examples, the user's personal information may remain hidden from potential employers. That is, the user may receive potential job opportunities based on their digital smart profile without any personal information being divulged. Rather, the centralized management server may keep the user's identity hidden unless authorized by the user to share such information.

According to the various embodiments, a digital smart profile may be a person's digital DNA. It may be encrypted for security and data privacy. The user may maintain complete control and transparency into how the data stored in the digital smart profile is used. Conceptual search/semantic technologies may be used to normalize data and terms. Business job descriptions and profiles may include skills according to business/industry. A skills library may provide a high level alignment with candidate skills. Conceptual search and semantic technologies may support further detailed alignment of terms. For example, a company may use a term “account executive” as a description of a salesperson. Candidates are known to use various terms for the same job including sales executive, account manager, and the like. Matching and gap analysis may be performed by the mobile application, and according to the gap, learning content may be provided to reduce or eliminate the gap. According to the user's digital smart profile, they may participate and engage in online groups and communities. Endorsements by peers will further enrich a person's profile. A business may use the mobile application to invite and engage qualified candidates at company or industry events. Skills and location data may be aggregated to provide market intelligence by skills.

The embodiments may also leverage the inherent capabilities of geo-location services of a user's mobile device and align the user's skills, competencies and career ambitions with suitable employment opportunities according to user selected filtering criteria and location. The examples herein may also leverage job profiles, skills and competencies, recruiting, learning and performance to understand job seeker capabilities and potential and then present relevant career opportunities, skill assessments and learning opportunities according to user selected preferences. The embodiments may further leverage conceptual search engines or the social grid to better learn and align skills and competencies with an individual's career ambitions thus eliminating or otherwise reducing the reliance on key word matching as a job search method and its inherent inefficiencies. Various embodiments may also provide users with intelligent career paths and online learning opportunities according to demonstrated skills and desired ambitions.

Furthermore, businesses may gain real-time insight into local, regional, and global talent markets through more precise analysis of labor market data. Businesses may evolve from legacy human resources having generic job profiles containing shallow and static human resource jargon to secure digital smart profiles enriched with skills, competencies, and real-time market data. Business profiles may further be enhanced with cultural attributes of the company providing job seekers with further insight into what it's like on the inside. Businesses leveraging this enriched framework may eliminate a vast majority of recruiting barriers, inefficiencies, and costs by establishing an automated human capital supply chain.

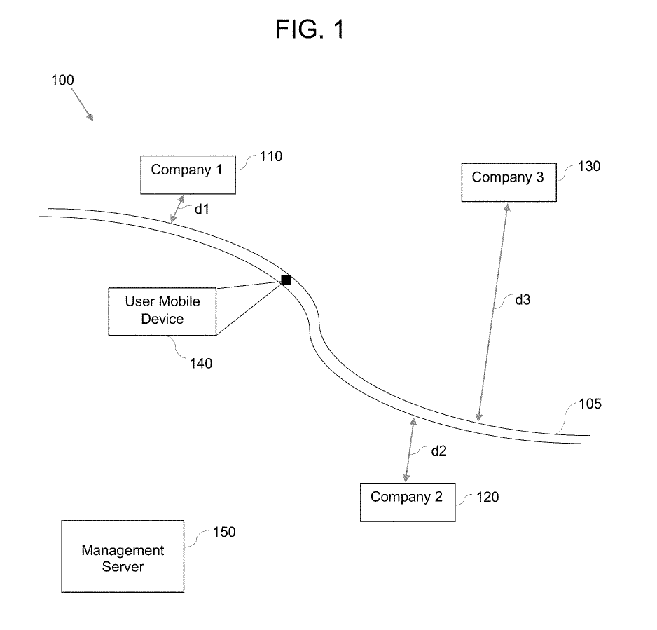

FIG. 1 illustrates an overview of a system 100 in which available job opportunities may be provided to a user based on a digital smart profile of the user, in accordance with an example embodiment. Referring to FIG. 1, the system 100 includes a first company 110, a second company 120, a third company 130, a mobile device 140, and a management server 150. The mobile device 140 corresponds to a user of mobile device 140 who is travelling along a path 105. Each of the mobile device 140 and the first through third companies 110-130 may be connected to the management server 150 via a network, for example, through the Internet, a cellular network, and the like. As a non-limiting example, the mobile device 140 may be a computer, a mobile phone, a tablet, a laptop computer, a phablet, a notebook, a smart wearable device, and the like. Furthermore, the first through third companies 110-130 may include one or more computing devices such as servers, computers, and the like, which may be connected to the management server 150.

According to various embodiments, the user may install a mobile application on the mobile device 140 having various embodiments incorporated therein. The mobile application may be downloaded from the management server 150. Using the mobile application, the user may build a digital smart profile. For example, in addition to including data from a resume and/or cover letter, the user may select from a library of skills which the user possesses, follow an adaptive assessment process, receive comments from others, and the like. As one example, the user may select from structured assessment tools provided by the management server 150 through the mobile application such as CEB/SHL assessments, a Reiss profile, and the like, to build the digital smart profile. As the user builds the digital smart profile, the mobile application may suggest additional skills assessments based on profiles of other users which are similar to the user. The mobile application may also suggest user or collaboration groups where the user may interact with like-minded users who possess similar skills, interests and/or digital smart profiles. The resulting digital smart profile may provide a comprehensive understanding of the attributes of a user including ambitions, skills, competencies, interests, hobbies, motivations, personality traits, and the like. The user can further choose which attributes the user would like the system 100 to use, for example, the user may choose not to show any attributes, or show only a partial amount of attributes.

From time to time (e.g., periodically or randomly) the mobile application may recommend additional skills to the user according to the user's social behaviors which are detected based on the user activity with the mobile device 140. For example, the mobile device 140 may detect various places the user frequents, applications and websites the user visits on a frequent basis, people the user interacts with using the mobile device 140 (e.g., social media, email, telephone, etc.), and the like. The user may also choose to have specialty skills assessed independently through an integrated third party cloud provider. Also, the user may choose to have their job skills assessed through various structured assessment techniques including gaming, social collaboration and recommendation points earned from peers. The user's skills assessment may result in, for example, skill pool inclusion with activated rights for collaboration, available job opportunity notifications, learning opportunities, and the like, which may be provided by the management server 150.

The options for building the digital smart profile may be completely up to the user allowing the user to consume as much features of the system 100 as they desire or none at all. Over time, the user may build a more detailed and meaningful digital smart profile based on interests, competencies, ambitions, interaction with others, and the like. Having complete control of the digital smart profile, the user may continually add or adjust the profile including even partial or complete removal of the user's personal data. While the user may delete their system profile, they may retain a personal copy to re-activate in the future if the user so desires. After creating the digital smart profile, the user may choose to activate, for example, a find jobs feature which may compare and match the user's digital smart profile (supply) with available job opportunities (market demand) according to attributes which the user selects.

In the example of FIG. 1, the user travels along the travel path 105 which may be the path from work to home. A geo-location of the mobile device 140 may be transmitted (e.g., continuously, periodically, randomly, etc.) to the managing server 150 or detected from the mobile application residing on the mobile device 140 In this case, the user may miss their daughter's soccer game due to heavy traffic. While the user is traveling, the mobile application installed on the mobile device 140 may be working in the background for the user matching the user's digital smart profile to companies within certain time and distance parameters of the user's commute (i.e., travel path 105). In this case, the management server 150 may push a notification to the user's mobile device 140 through the mobile application indicating that there are multiple new career opportunities which will leverage the user's recently acquired skills and passions, provide a structured career development plan, and provide one or more benefits of the available job opportunities such as a decrease in daily commuting time and an increase in annual compensation. The management server may also send a notification that the hiring managers for one of these opportunities has a child that participates in a youth soccer league and works for a company ranked excellent for work/life balance and social responsibility according to peer reported opinion surveys.

As yet another example, the management server may detect that the user is in heavy traffic based on their geo-location, and provide a notification that says “are you tired of this heave traffic, there are three job opportunities closer to your home that are available.” For example, based on the user's travel patterns, interests, hobbies, family interests, ambitions, and the like, which may be stored by the management server 150 over time, the management server 150 may provide notifications to the user. For example, the management server may be aware of the user's interests, the user's family interests, the interests and family interests of hiring professionals at available job opportunities, and the like, and may use this information to provide notifications to the user.

The management server may also determine which matching companies to provide notifications for based on a distance of the company from the user's travel path 105. In the example of FIG. 1, the first company 110 has a shortest distance d1 from the user's travel path 105, the second company 120 has a second shortest distance d2 from the user's travel path 105, and the third company has a farthest distance d3 from the user's travel path 105. The management server 150 may compare the distances (d1, d2, and d3) to a predetermined distance that may be set by the user or set as a default, and provide notifications of only those available jobs offered by companies within the predetermined distance. In the example of FIG. 1, the first company 110 and the second company 120 may be determined as being within the predetermined distance from the user's travel path 105 while the third company 130 may be determined as being outside of the predetermined distance from the user's travel path 105. Accordingly, even though all three companies (110, 120, and 130) have available job opportunities that match the digital smart profile of the user, the management server 150 may only push notifications of the available job opportunities of the first company 110 and the second company 120, and not the third company 130. As an example, the mobile application may provide a map on a display of the mobile device 140 illustrating a location of the first company 110 and the second company 120, and also display information about the available job opportunities at the companies. Also, although not shown in FIG. 1, the user may also be presented with virtual job opportunities in addition to or instead of office job opportunities. The virtual job opportunities may be discernible from the office job opportunities. In this case, the virtual job opportunities are not based on location, because they can be performed from home, at any location.

The user may review the available job opportunities immediately or at a later time on the mobile device 140 or on another device of choice. The user may also take action, for example, the user may choose to immediately use the pre-configured digital smart profile to request additional details, apply to the position, schedule an interview or FaceTime discussion with one of the companies in real time, and the like. As the user is reviewing available job opportunities, the user may also controls their options to interact with each company including engage, filter out, watch over time, or refine filters. Through the social collaboration feature, the user may be referred by others or request a recommendation by social peers. Social activities may also lead the user to being recommended by peers for future opportunities before the recruiting process begins at a particular company. A company's performance management and workforce planning processes may also predict a future need for the user's type of skills weeks or even months before the need becomes known and trigger pipelining and engagement activities with the user.

As another example, the user may also travel frequently for work or with his family on vacation. While travelling, the user may decide to explore the local labor market and schools for their children. Without requiring any prior knowledge of the area, the mobile application may perform the same skills matching to local businesses and adapt the location and travel requirements as the user has previously selected. In some examples, the mobile application may also be integrated with web based services including real-estate and various relocation services to provide the user a simple and comprehensive digital overview and cost analysis for relocation of the user and their family.

In the example of FIG. 1, the management server 150 may automatically provide information about available job opportunities determined as having attributes satisfied by the digital smart profile of the user, in response to the available job opportunity being located within a predetermined distance from the recurring travel pattern (e.g., travel path 105) of the user. For example, the mobile device 140 may provide information about the recurring travel pattern to the management server 150. The information about the recurring travel pattern may be detected by a global positioning system (GPS) receiver of the mobile device 140, or another geo-location system. The information about the recurring travel pattern may include multiple sets of GPS coordinates, a path of travel connecting the sets of GPS coordinates, and the like, of the mobile device 140 which may be continuously or periodically monitored, tracked, stored, etc., and transmitted or otherwise provided to the management server 150 through a wired or wireless connection. In response, the management server 150 may compare a geo-location of available job opportunities to geo-location information of the recurring travel pattern to determine whether the geo-location of an available job opportunity is within a predetermined distance from a geographical point on the recurring travel pattern of the mobile device. Accordingly, the management server 150 may provide the user of the mobile device 140 with information about available job opportunities that are determined to be within a predetermined distance from a recurring travel pattern of the mobile device 140. As a non-limiting example, a travel pattern such as travel path 105 may be determined as recurring if it occurs more than one, for example, if it occurs multiple times per week, and the like.

As another example, the management server 150 may automatically provide information about an available job opportunity in response to the user's mobile device 140 entering or coming within a predetermined distance of the available job opportunity. As another example, the management server 150 may automatically provide information about an available job opportunity in response to the available job opportunity being within a predetermined distance from an arbitrary target location input by the user through the mobile device 140.

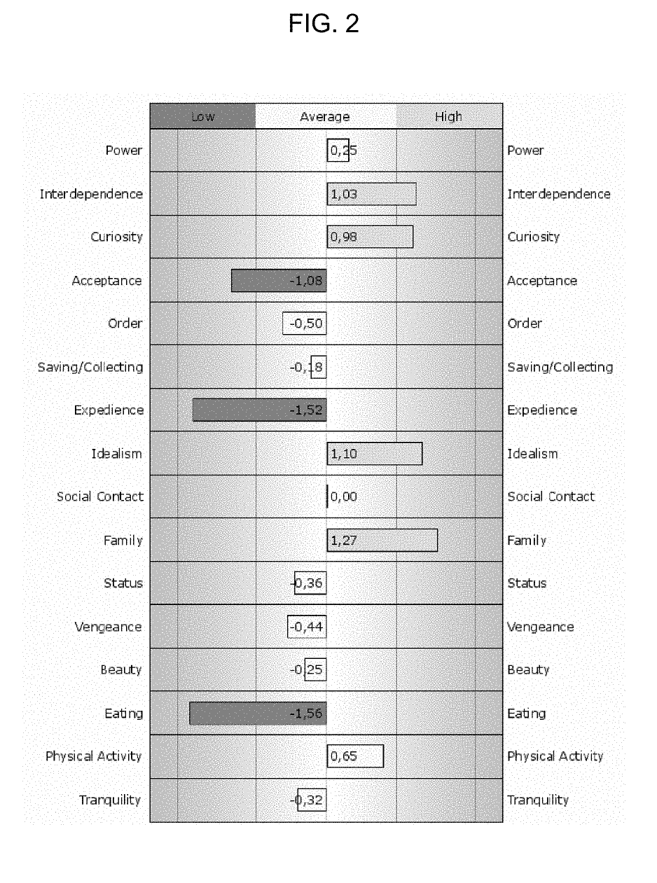

FIG. 2 illustrates a listing of attributes of a user that may be included in a digital smart profile in accordance with an embodiment. Referring to FIG. 2, a list of sixteen (16) basic motives are illustrated, however, the embodiments are not limited thereto. In this example, the user is given a score of low, average, or high based on answers they have provided to questions included in an assessment or a plurality of assessments which may be provided and scored by the management server 150 shown in FIG. 1. The scores for the attributes may be evaluated according to various embodiments to determine or make various inferences about a person, for example, what drives the person, how they are unique, what kind of personality do they have, what qualities can they excel in at a job, and the like. As a non-limiting example, the personality traits may be analyzed to determine leadership potential, interpersonal skills, problem solving skills, decision making skills, time management skills, organization skills, and the like. In the example of FIG. 2, the attributes are scored between low and high, however, other scoring may be performed such as numerical scoring.

One of the difficulties in finding a good candidate for a job is that resumes, social networking pages, and the like, often include information that is unchallenged and difficult to prove. For example, many people use social networking services such as LinkedIn, Viadeo, Facebook, and others, to build a professional wall illustrating various achievements such as education history, work experience, and the like. However, information that a person posts about themselves on a social networking site often goes unchallenged. Similarly, information that a person provides in a resume may be difficult to prove, such as individual course grades, achievements at a previous place of employment, and the like. Also, companies may accept a resume and its contents at face value, opting not to expend time and money performing a background search on a potential candidate. As a result, a person can mislead potential employers. Various embodiments overcome this problem by challenging a user with one or more assessments. As a result, the user's abilities, ambitions, interests, and the like can be challenged and put to the test to verify or detect that they exist and at what level and ability.

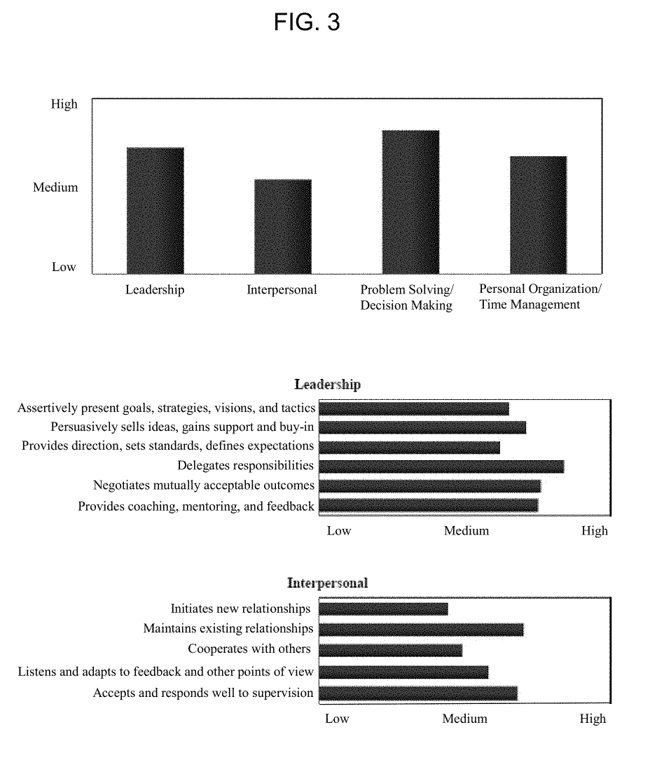

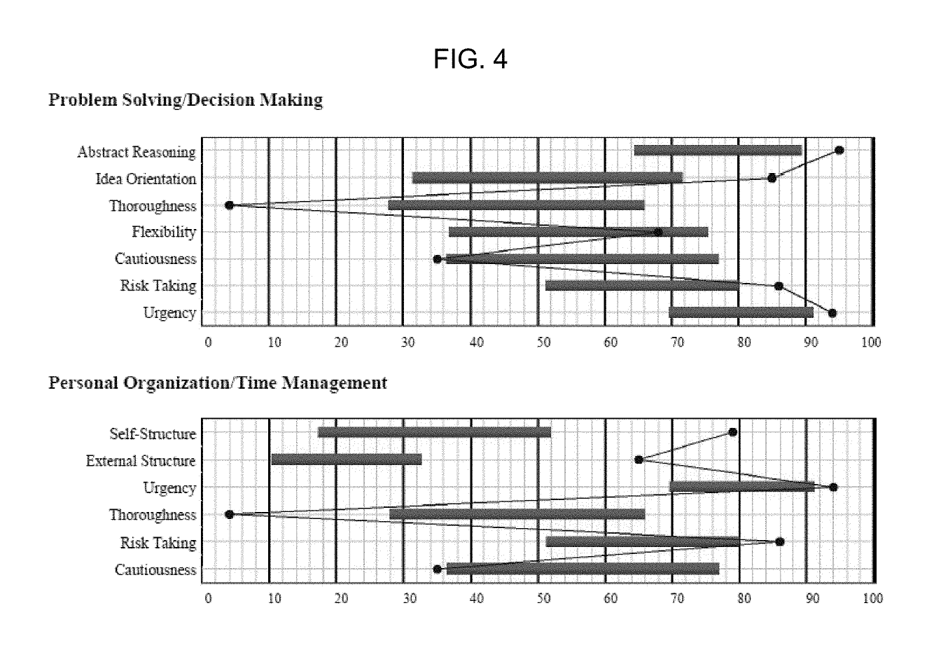

FIGS. 3 and 4 illustrate personality evaluations that may be generated from and/or included within a digital smart profile in accordance with various embodiments. The personality evaluations may be based on answers given by the user to various assessments. Referring to FIG. 3, assessments may be analyzed and processed to determine various skills of the user, for example, leadership skills, interpersonal skills, and the like. As another example, referring to FIG. 4 the assessments may be analyzed and processed to determine problem solving capabilities and decision making capabilities of the user, personal organization skills, and time management skills. In these examples, the personality evaluations shown in FIG. 2 (as well as any other desired information) may be used to make the determinations in FIGS. 3 and 4. It should also be appreciated that the skills and capabilities determined in FIGS. 3 and 4 are only for purposes of illustration, and may be any desired skill or capability desired by a potential employer.

Assessments may include questions for which there is no right or wrong answer, for example, do you prefer an evening at the opera or a sporting event, do you prefer hiking in the mountains or walking through a city, would you be more successful selling cars, designing and engineering cars, building cars or racing cars, would you be more successful being a Medical Researcher or a Doctor, would you prefer to donate cash or physically engage in charitable events, and the like. Based on the answers provided, the attributes of the user may be generated and various skills, ambitions, hobbies, and the like of the user may be inferred or determined by evaluating the attributes. Businesses looking to hire new employees may be interested in certain attributes which are not necessarily evident from a resume or a cover letter. For example, if a job seeker has a high score for an attribute of curiosity, it may be inferred that the job seeker is interested in learning new things. Any number of different attributes can be determined based on the assessments, and a user may decide which attributes they would like the system to use to search for available job opportunities.

In FIGS. 3 and 4, the attributes of the user are evaluated and used to determine a value for different skills which may be of interest to a potential employer. In FIG. 3, the user is given overall scores from low to high for skills including leadership, interpersonal, problem solving/decision making, and personal organization/time management. Also, each of these skills may be further evaluated to determine individual factors within each skill. For example, leadership includes scores for individual factors such as assertiveness, persuasiveness, ability to provide direction, delegation abilities, negotiating capabilities, and mentoring skills. As another example, interpersonal includes individual scores for factors such as initiating new relationships, maintaining current relationships, cooperation abilities, listening skills, and acceptance to supervision. In these examples, the management server 150 may determine these scores, or the businesses may be provided with the user's attributes and determine the scores on their own. In FIG. 4, problem solving/decision making includes ranges of scores for individual factors such as abstract reasoning, idea orientation, thoroughness, flexibility, cautiousness, risk taking, and urgency. Also, personal organization/time management includes ranges of scores for individual factors such as self-structure, external structure, urgency, thoroughness, risk-taking, and cautiousness.

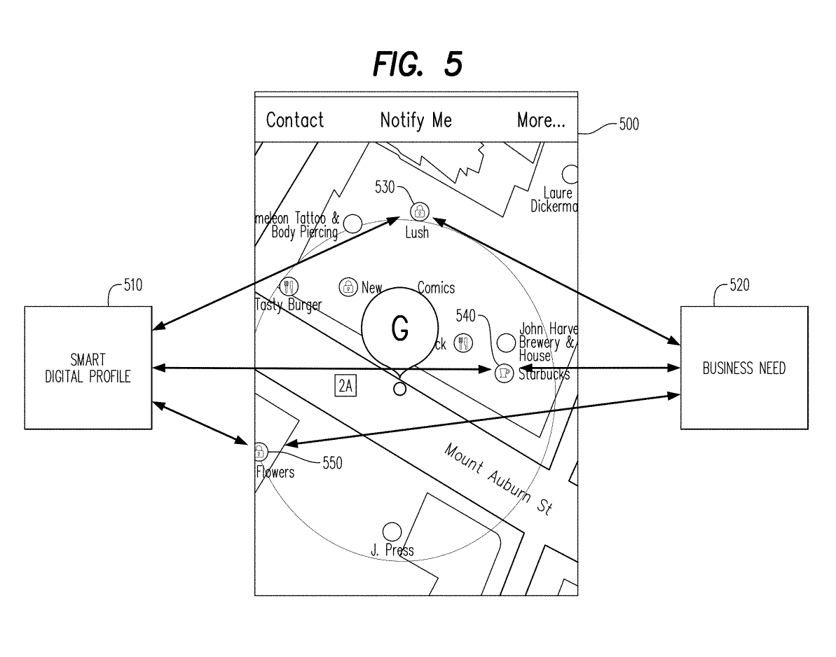

FIG. 5 illustrates a display screen 500 of a mobile device showing available job opportunities available that are provided based on a user's digital smart profile in accordance with an example embodiment. In this example, the user's digital smart profile satisfies predetermined criteria for three available job opportunities including a job with company 530, company 540, and company 550. It should be appreciated that the user's digital smart profile does not need to satisfy all of the predetermined criteria for an available job opportunity, but may satisfy a predetermined amount of factors, for example, 50%, 80%, and the like, in order for the job opportunity to be provided to the user. In this example, digital smart profile 510 is matched with business needs 520 of three companies 530, 540, and 550. The display screen 500 further shows a map of the area in which the companies are located as well as the routes for getting there and other stores and/or business in the area.

Table 1 shown below illustrates various general employee competencies that a company, in this case Company X, is looking for. The embodiments herein may determine a user's competencies based on the attributes of the user from their digital smart profile and compare the competencies to Company X's desired competencies. An example of Company X's desired competencies is shown below.

TABLE 1

| Company X Competencies | Level (1-4) |
|---|---|
| Core Competencies | |
| Customer Focus | 4 |
| Business Acumen | 4 |
| Innovative Thinking | 4 |
| Company X Employee Competencies | |
| Challenge Complexity | 4 |
| Change Agility | 4 |
| Communication | 4 |
| Intercultural Sensitivity | 4 |
| IT Principles & Data Security | 3 |
| Partner & Third Party Engagement | 4 |
| Quality Focus | 4 |
| Results-Driven | 4 |
| Self-Development | 4 |
| Teamwork & Collaboration | 4 |
| Company X Leadership Principles | Level (1-4) |
| Drive Simplicity | 3 |
| Develop Amazing Talent | 3 |
| Ensure Customer Success | 3 |

In this case, Company X may correspond to one of companies 530 thru 550 in FIG. 5. According to various aspects, the digital smart profile 510 of the user may be determined to be a match for Company X based on a predetermined number of competencies of Company X being satisfied based on the user's digital smart profile 510. Accordingly, the management server may provide available job opportunity information about Company X to the user represented by digital smart profile 510.

Table 2 shown below illustrates various job specific competencies and skills that a company, for example, Company X, is looking for with respect to a specific available job opportunity. Various embodiments may determine a user's job specific competencies based on the attributes of the user from their digital smart profile and compare the competencies to the desired job specific competencies and skills for Company X to determine whether a user is a match for an available job opportunity with Company X.

TABLE 2

| Job Specific Competencies & Skills | Level (1-4) |
|---|---|
| Conflict Management | 4 |
| Project Management | 3 |
| Business Economics/Administration | 4 |
| Team Lead Capabilities | 3 |
| Managing Virtual Teams | 3 |
| Executives Communication | 3 |
| Organizational Know How | 4 |
| Finance Principles and Policies | 4 |
| Financial Analysis | 3 |
| IT Controlling & Reporting | 3 |
| Operation Risk Management Methodology | 4 |
| Operation Risk Management Process | 4 |
| Risk Assessment | 4 |
| Enterprise Risk Management | 4 |
| Financial Governance, Risk & Compliance | 4 |
| Thought Leadership | 3 |
| Contribution to Knowledge Sharing | 3 |

It should also be appreciated that these competencies are merely examples and should not be construed as limiting the scope of the embodiments. It should also be appreciated that additional factors, attributes, skills, and the like of a job seeker may be considered by the system during a comparison of a digital smart profile to potentially available job opportunities.

In the example of FIG. 5, a user of the device may interact with the graphical display to select an available job opportunity to learn more about the opportunity. For example, the user may select a highlighted icon on the map corresponding to the first job opportunity, and the management server may provide additional information about the available job opportunity, for example, job skills, interests, work/family life balance, information about hiring professionals at the job opportunity, financial compensation, career path potential, and the like. As another example, the management server may provide learning information about the job opportunity to the user based on the user's digital smart profile.

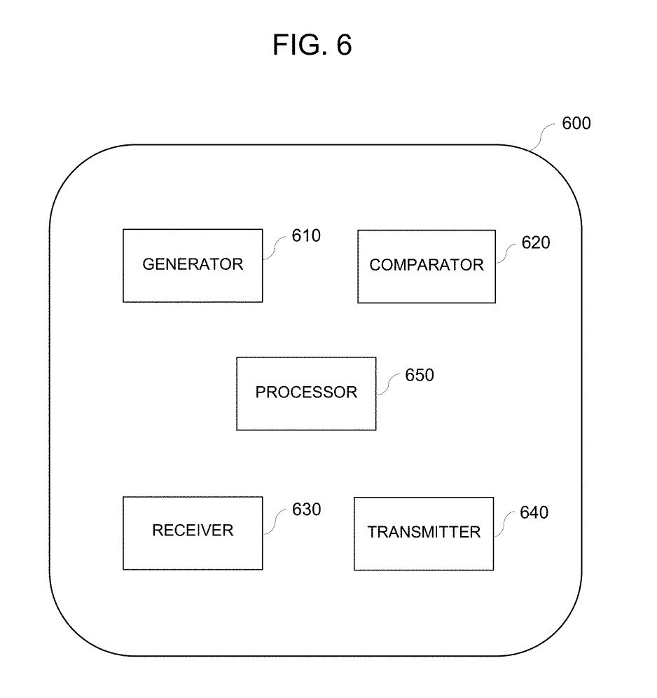

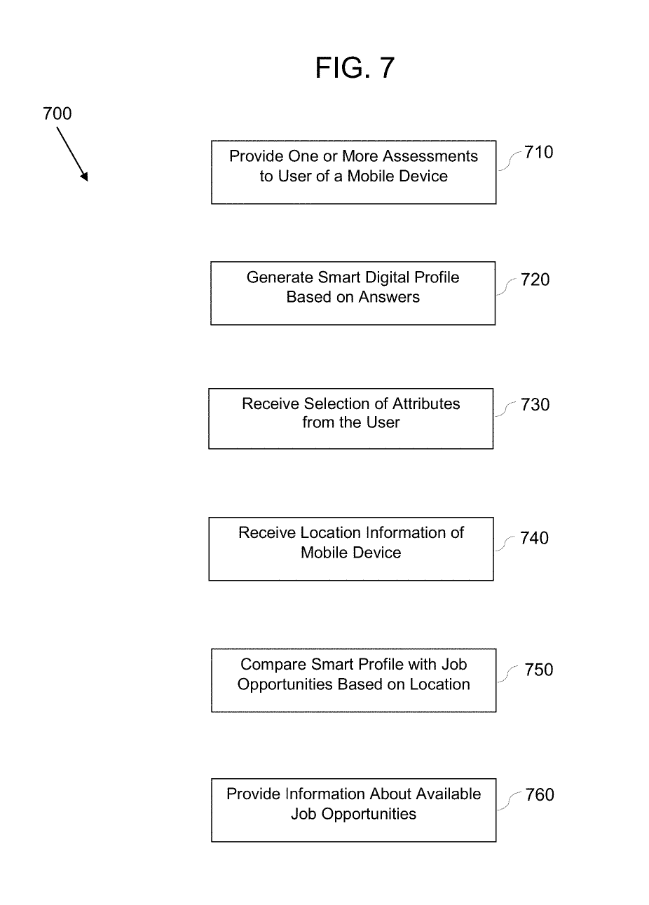

FIG. 6 illustrates a management server 600 and FIG. 7 illustrates a method 700 performed by a management server, in accordance with an embodiment. In these examples, the management server 600 may be the management server 150 shown in FIG. 1 and may be an application server such as a mobile application providing server, and the like. According to various embodiments, the management server 600 may generate a digital smart profile for a user of a mobile device and search for and find available job opportunities for the user based on the digital smart profile.

Referring to FIG. 6, the management server 600 includes a generator 610, a comparator 620, a receiver 630, a transmitter 640, and a processor 650. It should also be appreciated that the management server 600 may include other additional components not shown. Also, the receiver 630 and the transmitter 640 may correspond to a network interface capable of connecting to the Internet, a cellular transceiver capable of receiving data wirelessly through radio waves, and the like.

Referring to FIGS. 6 and 7, in 710 one or more assessments are provided to a mobile device such as mobile device 110 shown in FIG. 1. For example, the one or more assessments may be transmitted by the transmitter 640. The user may answer questions included within the assessments and provide the answers which may be received by the management server 600, for example, through the receiver 630. The assessments may include at least one of a personality assessment, an aptitude assessment, a knowledge and skills assessment, a job fit assessment, a customized assessment, and the like.

In response, in 720, a digital smart profile of the user is generated based on the answers to the assessment. For example, the digital smart profile may include a plurality of attributes of the user that are determined based on the answers to questions included in the assessment and may be generated by the processor 650. A representation of the generated digital smart profile may be provided to the user of the mobile device by the management server 600, for example, through a mobile application displayed on the user's mobile device. The user may select one or more attributes from the user's digital smart profile that the user wants to use to search for available jobs. In 730, the one or more attributes selected by the user may be received from the mobile device. For example, the user may want potential employers to consider only certain results from a personality test, or certain portions of the user's ambitions, and accordingly, the user may select those certain results or portions, and choose to hide the remaining results and portions.

In some embodiments, the management server 600 may further receive location information from the mobile device, in 740. For example, the location information may include a GPS position of the mobile device, a recurring routing path of the mobile device, an arbitrary location input by the user of the mobile device, and the like. The location information may be received by the receiver 630. Here, the processor 650 of the management server 600 may determine a distance from the user's location information to available job opportunities and use the distance to determine which available jobs to provide information for.

In 750, the comparator 620 may compare the digital smart profile of the user to predetermined criteria desired by available job opportunities and determine an available job opportunity or a plurality of available job opportunities having predetermined criteria satisfied by the digital smart profile of the user. In some examples, the comparator 620 may compare the attributes selected by the user and received in 740 to attributes required or desired by available job opportunities, and provide a notification of available job opportunities in 760 to the user of the mobile device having predetermined attributes which match or partially match the user selected attributes of the digital smart profile. In some examples, the comparator 620 may also use a location of the mobile device to filter available job opportunities, or to push available job opportunities to the mobile device of the user.

For example, the comparator 620 may compare a location of the available job opportunity having the predetermined attributes matching the plurality of attributes of the digital profile to a geo-location of the mobile device to determine an available job opportunity having predetermined attributes matching the plurality of attributes of the digital profile of the user and also having a geo-location within a predetermined distance from the geo-location of the mobile device. As another example, the transmitter 640 may provide or automatically push information about an available job opportunity determined as having attributes satisfied by the digital smart profile to a mobile device of the user in response to a geo-location such as an actual location of the user or an arbitrary location input by the user being within a predetermined distance of the location of the available job opportunity. Also, the processor 650 may determine one or more benefits associated with an available job opportunity in comparison to a current job of the user detected by the management server 600, and the transmitter 640 may provide the one or more benefits to the mobile device of the user.

For example, the transmitter 640 may automatically push a notification about an available job opportunity determined as having attributes satisfied by the digital smart profile, to the mobile device, in response to the mobile device being within a predetermined distance of the available job opportunity or within a predetermined distance from a recurring travel pattern of the user's mobile device. When automatically pushing a notification to the mobile device, the management server 650 may not wait for a request from the user of the mobile device, but instead, may automatically detect job opportunities as the user moves around and automatically transmit notifications (i.e., push) when the mobile device of the user is detected as being within a predetermined distance of an available job opportunity which is satisfied by the user's smart digital profile and which may be of interest to the user based on settings and/or interests which may be provided by the user in advance or detected from a user's mobile device use. In some examples, the management server 600 may detect various career interests, job interests, ambitions, career path goals, and the like, about the user of the mobile device based on the user's activity on the mobile phone using a mobile application provided by the management server 600 and installed on the mobile device.

Although not shown in FIG. 7, the method may further include determining by the processor 650 an available job opportunity having at least one attribute which the digital smart profile of the user does not satisfy, and providing by the transmitter 640 learning content to the user based on the at least one attribute that the user does not satisfy. As another example, the user may design a career path using the mobile application provided by the management server 600. In this example, the management server 600 may periodically provide the user with learning material based on the user's desired career path such that the user is more qualified for future positions that the user is interested in. Also, the management server 600 may detect available job opportunities based on the user's desired career path.

Although not shown in FIG. 7, the management server 600 may enrich the user's digital smart profile over time, based on information that management server 600 gathers about the user over time. For example, the management server 600 may keep track of interests, hobbies, jobs, ambitions, contacts, social networking interaction, emails, and the like, of the user, and further enrich the digital smart profile based on this information that is gathered over time.

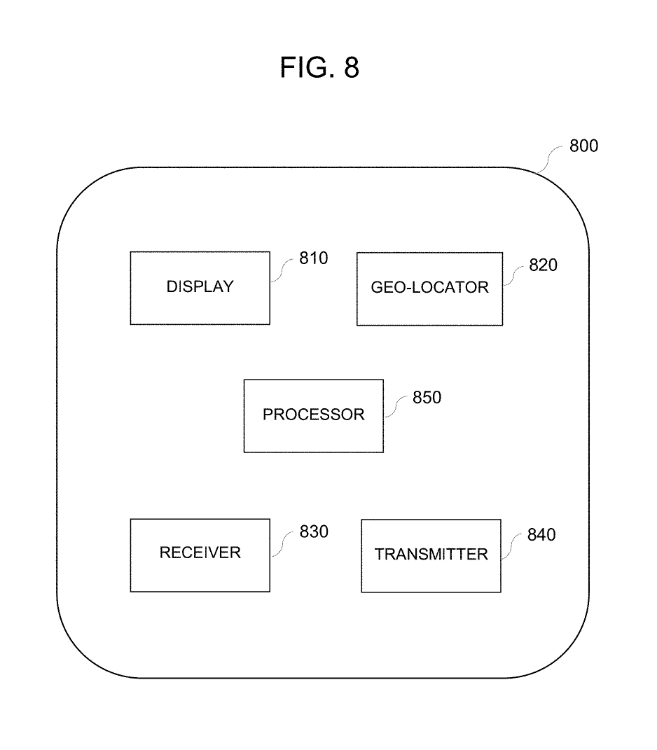

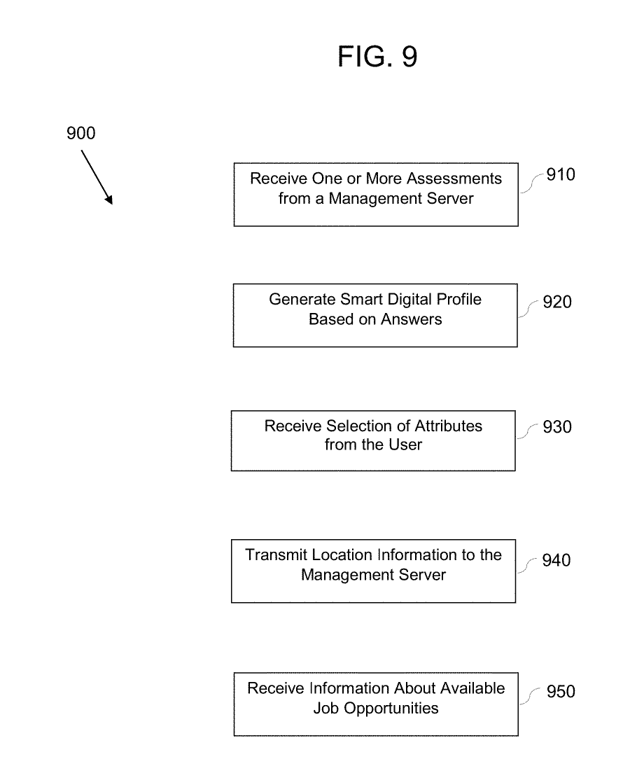

FIG. 8 illustrates a mobile device 800 and FIG. 9 illustrates a method 900 of a mobile device in accordance with example embodiments. The mobile device 800 may be the mobile device 140 shown in FIG. 1 and may be a mobile phone, a tablet, a notebook, a laptop, a phablet, an MP3 player, a wearable smart device, a computer, and the like. In the example of FIG. 8, the mobile device 800 includes a display 810, a geo-locator 820 (such as a global positioning system), a receiver 830, a transmitter 840, and a processor 850. It should also be appreciated that the mobile device 800 may include other additional components not shown. Also, the receiver 830 and the transmitter 840 may correspond to a network interface capable of connecting to the Internet, a cellular transceiver capable of receiving data wirelessly through radio waves, and the like.

Referring to FIGS. 8 and 9, in 910, the mobile device 800 receives one or more assessments from a management server. For example, the receiver 830 may receive an assessment from a mobile application server (such as management server 150) while the processor 850 is executing a mobile application according to the embodiments on the mobile device 800. The assessment may include at least one of a personality assessment, an aptitude assessment, a knowledge and skills assessment, a job fit assessment, and a customized assessment. A user of the mobile device 800 may input answers to the assessment, for example, through an input unit (not shown). In 920, the mobile device may generate a digital smart profile of the user by transmitting the answers to the assessment to the management server. For example, the transmitter 840 may transmit the answers to the management server. As a result of the digital smart profile being generated, a number of attributes of the user may be stored within the digital smart profile, for example, the attributes shown in FIG. 2 or derived from those attributes as shown in FIGS. 3 and 4. In 930, one or more of the attributes from the digital smart profile may be selected by the user (through the input unit) and may be used to represent a profile of the user for seeking a job.

In addition, the geo-locator 820 may continuously, periodically, or randomly detect a geo-location of the mobile device 800 and in 940 the transmitter 840 may transmit the detected location to the management server. As another example, the user may input an arbitrary location that is not based on the user's current location, and the transmitter 840 may transmit the arbitrary location to the management server. Accordingly, the management server may search for available job opportunities for the user based on the user's location information and based on the user's digital smart profile or the features selected by the user from the user's digital smart profile.

In 950, the receiver 830 may receive a notification about an available job opportunity for the user. In this example, the notification may be automatically pushed from the server, and may be in response to the selected user attributes of the digital smart profile satisfying predetermined attributes of the available job opportunity and/or in response to the geo-location being within a predetermined distance of a location of the available job opportunity. The display 810 may display a map and a location of the available job opportunity within the map on a screen of the mobile device 800. In some examples, the receiver 930 may further receive one or more benefits associated with the available job opportunity in comparison to a current job of the user of the mobile device 800 and the display 810 may display the benefits at a location corresponding to a location of the available job opportunity on the map.

According to various aspects, the embodiments provide a mobile environment which removes barriers preventing businesses with employment opportunities and qualified people from identifying and interacting with each other. Various embodiments enable qualified interaction between businesses and job seekers based on digital smart profiles and regardless of brand recognition, geography, commuting requirements and/or other intangible details. Data privacy and security of the user's personal identify may be maintained while providing flexibility to allow the user, regardless of where they are located in the world, to have complete transparency and control over how their digital smart profile is used in accordance with local data privacy laws.

A digital smart profile may allow for digital wrapping of each entity included within the mobile application. The digital wrapping may open a powerful channel for interaction beside a traditional physical channel. In this case, a new digital channel is made available based on personality traits, ambitions, career goals, and the like, which may be tested and determined by the examples herein, and which may not be readily apparent from a resume. As a result, it is possible for businesses and potential employees to have more meaningful remote interaction via their digital profiles without direct physical contact.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific embodiments, it should be understood that various changes, substitutions, and alterations apparent to those skilled in the art can be made to the disclosed embodiments without departing from the spirit and scope of the invention as set forth in the appended claims.

What is claimed is:

1. A server comprising:
a receiver configured to receive answers from a user of a mobile device to questions included in an assessment and to receive recurring travel pattern information of the mobile device detected by a global positioning system (GPS) detector of the mobile device;
a generator configured to generate a digital profile based on the answers by the user to the questions included in the assessment, the digital profile comprising attributes of the user that are determined based on the answers;
a comparator configured to compare the digital profile to available job opportunities to determine an available job opportunity having predetermined attributes matched by the attributes of the digital profile; and
a transmitter configured to automatically push information about the available job opportunity having predetermined attributes matched by the attributes of the digital profile to the mobile device of the user, in response to the available job opportunity having a geo-location within a predetermined distance from a geo-location of the recurring travel pattern information.

2. The server of claim 1, wherein the comparator is further configured to compare a geo-location of the available job opportunity having the predetermined attributes matched by the attributes of the digital profile to a geo-location of the recurring travel pattern information of the mobile device to determine an available job opportunity having predetermined attributes matched by the attributes of the digital profile and having a geo-location within a predetermined distance from the geo-location of the recurring travel pattern information of the mobile device.

3. The server of claim 1, wherein the recurring travel pattern information comprises a recurring travel path of the mobile device based on a plurality of GPS coordinates detected by the GPS detector of the mobile device.

4. The server of claim 1, wherein information about at least one available job opportunity having predetermined attributes matched by the attributes of the digital profile is not transmitted to the mobile device of the user in response to the available job opportunity having a geo-location that is not within the predetermined distance from the geo-location of the recurring travel pattern information of the mobile device.

5. The server of claim 1, wherein the receiver is further configured to receive a target location input by the user of the mobile device, and
the transmitter is configured to automatically push a notification about the available job opportunity determined as having attributes matched by the attributes of the digital profile, to the mobile device, in response to the available job opportunity having a geo-location within a predetermined distance from the target location.

6. The server of claim 1, wherein the receiver is further configured to receive, from the mobile device, a selection by the user of at least one attribute included in the digital profile, and the comparator is configured to compare the selected at least one attribute of the digital profile to available job opportunities to determine an available job opportunity having predetermined attributes matched by the selected at least one attribute of the digital profile.

7. The server of claim 1, wherein the transmitter is further configured to provide information about one or more benefits associated with the available job opportunity in comparison to a current job of the user.

8. The server of claim 7, wherein the information about the one or more benefits comprises an improved commute time from home to a geo-location of the available job opportunity in comparison to a commute time from home to a geo-location of the user's current job.

9. The server of claim 1, wherein the assessment used to generate the digital profile comprises at least one of a personality assessment, an aptitude assessment, a knowledge and skills assessment, a job fit assessment, and a customized assessment.

10. The server of claim 1, wherein the plurality of attributes of the digital profile comprise personality traits of the user and ambitions of the user.

11. The server of claim 1, wherein the comparator is further configured to determine an available job opportunity having at least one attribute which is not matched by the attributes of the digital profile of the user, and the transmitter is further configured to provide learning content from the server to the mobile device based on the at least one attribute which is not matched by the attributes of the digital profile of the user.

12. A mobile device comprising:
a processor configured to receive an assessment from a server and generate a digital profile of a user of the mobile device based on answers of the user to questions included in the assessment;
a global positioning system (GPS) detector configured to detect recurring travel pattern information of the mobile device;
a transmitter configured to transmit a user selection of attributes included in the digital profile and the recurring travel pattern information to the application server; and
a receiver configured to receive a notification about an available job opportunity for the user which is automatically pushed from the server, in response to predetermined attributes of the available job opportunity being matched by the user selected attributes of the digital profile and in response to the available job opportunity having a geo-location within a predetermined distance from a geo-location of the recurring travel pattern information.

13. The mobile device of claim 12, further comprising a display configured to display a map and a location of the available job opportunity within the map.

14. The mobile device of claim 12, wherein the recurring travel pattern information comprises a recurring travel path of the mobile device that is based on a plurality of GPS coordinates detected by the GPS detector.

15. The mobile device of claim 12, wherein the receiver further receives one or more benefits associated with the available job opportunity in comparison to a current job of the user of the mobile device.

16. The mobile device of claim 12, wherein the assessment used to generate the digital profile comprises at least one of a personality assessment, an aptitude assessment, a knowledge and skills assessment, a job fit assessment, and a customized assessment.

17. The mobile device of claim 12, wherein the user selected attributes of the digital profile comprise at least one of personality traits of the user and ambitions of the user.

18. A computer-implemented method comprising:
providing an assessment comprising a plurality of questions to a user;
generating a digital profile based on answers by the user to the questions included in the assessment, the digital profile comprising attributes of the user that are determined by a profile server based on the answers;
receiving recurring travel pattern information of the mobile device detected by a global positioning system (GPS) detector of the mobile device;
comparing the digital profile to available job opportunities to determine an available job opportunity having predetermined attributes matched by the attributes of the digital profile; and
automatically pushing information about the available job opportunity having predetermined attributes matched by the attributes of the digital profile to the mobile device of the user, in response to the available job opportunity having a geo-location within a predetermined distance from a geo-location of the recurring travel pattern information.

19. The computer-implemented method of claim 18, wherein the recurring travel pattern information comprises a recurring travel path of the mobile device based on a plurality of GPS coordinates detected by the GPS detector of the mobile device.

20. The computer-implemented method of claim 18, wherein information about at least one available job opportunity having predetermined attributes matched by the attributes of the digital profile is not transmitted to the mobile device of the user in response to the available job opportunity having a geo-location that is not within the predetermined distance from the geo-location of the recurring travel pattern information of the mobile device.

21. A non-transitory computer readable medium having stored therein instructions that when executed cause a computer to perform a method comprising:
providing an assessment comprising a plurality of questions to a user;
generating a digital profile based on answers by the user to the questions included in the assessment, the digital profile comprising attributes of the user that are determined by a profile server based on the answers;
receiving recurring travel pattern information of the mobile device detected by a global positioning system (GPS) detector of the mobile device;
comparing the digital profile to available job opportunities to determine an available job opportunity having predetermined attributes matched by the attributes of the digital profile; and
automatically pushing information about the available job opportunity having predetermined attributes matched by the attributes of the digital profile to the mobile device of the user, in response to the available job opportunity having a geo-location within a predetermined distance from a geo-location of the recurring travel pattern information.
